(19) United States
(12) Patent Application Publication
(10) Pub. No.: US 2008/0210358 A1
(43) Pub. Date: Sep. 4, 2008

(54) Method for Producing a Lead

(76) Inventor: Supachai Molander, Stockholm (SE)

Correspondence Address: DICKSTEIN SHAPIRO LLP, 1825 EYE STREET NW, Washington, DC, 20006-5403, US

(21) Appl. No.: 11/997,524

(22) PCT Filed: Jul. 25, 2006
(86) PCT No.: PCT/SE2006/000908

§ 371 Date: Jan. 31, 2008

(30) Foreign Application Priority Data
Aug. 2, 2005 (SE) 0501761-1

(51) Int. Cl. H01B 13/06

(52) U.S. Cl. 156/53

(57) ABSTRACT

Method for producing a lead (4, I) 1 comprising an elongate conductor (7) and a helically shaped string (4) of insulator mate-rial coaxially carried by the conductor, which string has axi-ally spaced-apart winding turns, which abut against and along the conductor. The string (4) is formed of a tubular blank (1) having a greater inner diameter than the outer diameter of the conductor (7). The tubular blank (1) is cut along a helically shaped path (2) coaxial with the blank. The cut blank (1, 2) is threaded coaxially onto the conductor (7) and is axially extended. Also, the lead manufactured by the method is claimed.

The invention relates to a method for producing a lead, of the kind that is seen in the preamble of claim 1.

It is previously known that it is possible to achieve a particularly good signal-transfer performance for a lead or for a cable formed by two or more such leads connected in parallel. Such a good signal-transfer performance is desirable, for instance for audio equipment, for the transfer of audio signals or electrical power (for instance main cables for audio equipment). Such a good signal-transfer performance is attained by a lead that comprises an elongate conductor and a helically shaped string of insulator material coaxially carried by the conductor, which string has axially spaced-apart winding turns. By such a structure, the string forms a contact protection for the conductor, the conductor primarily being surrounded by an air layer between the winding turns of the string, which rests on the surface of the conductor and consists of a good insulator, for instance Teflon®. In that connection, the conductor should be relatively thin and may as an example have a diameter of 0.5 mm for audio purposes, but also smaller conductor diameters are suitable, for instance 0.1 mm. The string should have a radial thickness that is considerable smaller than the conductor diameter, the insulator string suitably having a diameter that is a fraction, for instance one tenth, of the conductor diameter.

It is previously known to produce such leads by winding, with spaced-apart winding turns, an insulator strand on and around an elongate straight conductor. The known technique is associated with a number of difficulties associated with the low strength levels of the conductor and the insulator strand associated with the dimensions, and furthermore there are problems in respect of establishing conformal distances between the winding turns of the insulator string on the conductor, and a good contact between the conductor and the insulator string. Therefore, in order to produce leads of the mentioned kind, very high costs arise, for instance SEK 100 000 for an audio cable having a length of 5 m.

U.S. Pat. No. 5,286,923 reveals a lead of the previously known kind.

An object of the invention is to provide a method for producing a lead of the kind in question, the intention being to protect the method and the lead manufactured by the method.

The method according the invention is defined in the appended independent method claim.

Embodiments of the invention are defined in the dependent appended method claims.

The lead is claimed in an independent product claim that is based on the method.

A lead according to the invention can be distinguished from leads manufactured by the winding of a strand in a helical shape around the conductor, for instance by the cross-section shape and state of stress of the string, and shape memory, respectively, of the string mounted on the conductor.

In the following, the invention will be described by way of examples.

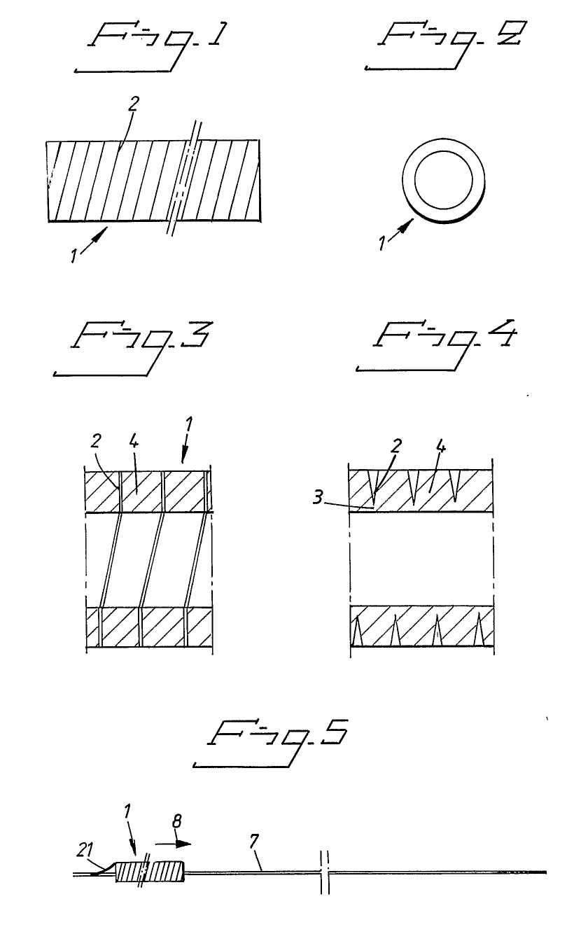

FIG. 1 shows a schematic side view of a tubular and externally helically shaped cut blank of an insulator material.

FIG. 2 shows an end view of the blank according to FIG. 1.

FIG. 3 schematically shows an axial section through a first embodiment of the blank according to FIG. 1 or 2.

FIG. 4 shows a schematic axial section through another embodiment of the blank according to FIG. 1 or 2.

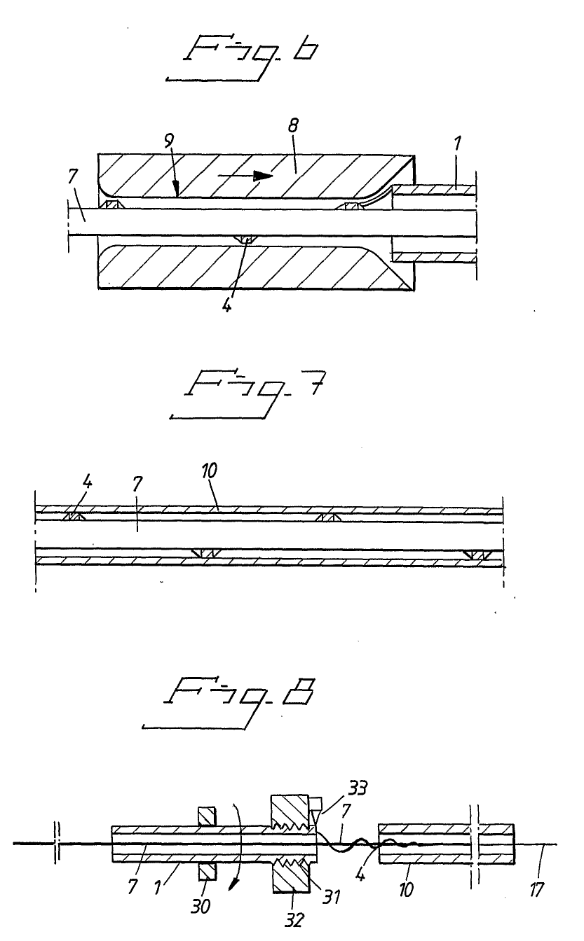

FIG. 5 schematically shows that a longitudinal portion of the blank initially is mounted on an end part of a conductor in one step in the manufacturing method

FIG. 6 schematically shows a tool for axial extension of the cut blank into a helically shaped string, which has axially spaced-apart winding turns being in contact with the conductor.

FIG. 7 shows an axial section through a lead that is stabilized by a protective cover abutting coaxially outside the winding turns of the string.

FIG. 8 shows an axial section through a schematically shown device for the manufacture of a product according to the invention.

In FIG. 1, a tubular blank 1 of an insulator material is shown. The blank is shown provided with a helically shaped cut 2, the pitch of which suitably is of the same size as the wall thickness of the blank. FIG. 2 illustrates that the inner surface of the blank may be smooth.

FIG. 3 illustrates that the cut 2 extends through the entire wall thickness of the blank 1 for the formation of a helically shaped strand 4 having axially adjacent winding turns. The strand 4 is shown substantially quadratic, but may also be rectangular or rhombic. The manufacturing method may include that a cutting tool has a through-put opening, the free inner diameter of which is smaller than the outer diameter of the insulator blank 1 and which is provided with a helical thread, which under deformation of the insulator material interacts with the same so that the tool upon coaxial rotation in relation to the tubular blank 1 allows a cut blade mounted on the tool to produce the cut 2. The cut blade (not shown) is then suitably oriented at an angle corresponding to the pitch angle of the thread. The cut blade may be oriented to establish a rectangular cross section of the string, or a rhombic cross section of the string.

In FIG. 4, an embodiment is illustrated, in which the cut 2 does not extend entirely through the tubing wall of the blank but at the bottom thereof leaves a material bridge 3, which holds together the winding turns of the string 4 defined by the cut 2. The bridges 3 may easily be broken through by axial expansion of the blank 1.

FIG. 5 illustrates an elongate conductor having a diameter of, for instance, 0.5 mm. The blank 1 is shown threaded coaxially on an end part of the conductor 7. The string end 21 of the blank is connected to the end of the conductor 7, and then the blank 1 is displaced in the direction of the arrow 8 toward the other end of the conductor 7. The blank 1 has a free inner diameter that is greater than the outer diameter of the conductor 7, whereby the blank 1 readily can be threaded onto the end portion of the conductor 7. Upon the displacement of the blank 1 along the strand, the pitch of the winding turns of the string 4 will increase, whereby the axially extended string 4 will be brought into contact with the conductor 7 around the surface thereof. The string 4 will successively be brought into contact with the circumference of the conductor 7 from the rear end of the blank 1 in the displacement direction 8 of the blank, when the blank 1 is urged at the rear end thereof.

As an alternative, the inner surface of the blank may be splined (not shown) generally in the axial direction of the blank, for instance so that the inner surface substantially forms wedges tapering toward the centre of the blank, whereby the abutment surface of the strand 4 against the conductor 7 may be decreased.

The free inner diameter of the blank 1 may, for instance, be selected so that the pitch of the string 4 increases, for instance, 20 times, before the string is brought into full contact with the conductor 7.

In FIG. 6, a tubular tool 8 is shown for guided axial displacement of the blank 1 from the end thereof fixed to the conductor 7. The tool 8 has a circular throughput passage 9, which widens toward the front end of the tool 8. The inner diameter of the channel 9 is selected to be a well determined dimension so that the channel wall induces a definite friction interaction with the outside of the individual winding turns of the string, whereby the winding turns of the string are pulled apart axially by a predetermined force from each other and thereby gets a well predetermined spacing.

FIG. 7 illustrates an axial section through a lead that has been provided with a protective tube 10 coaxially around the string 4 abutting on and around the conductor 7, which string has axially spaced-apart winding turns, the pitch of the winding turns of the string may be at least 10 times the diameter of the string.

The casing 10 may be in the form of a shrink tube, which initially has a free inner diameter that is substantially greater than the outer diameter of the string 4 having spaced-apart winding turns abutting on the conductor 7, and then has been shrunk in place in order to contact the string 4, so that the winding turns thereof are kept in place mutually. The tube 10 also forms a contact protection for the conductor in the area between adjacent winding turns. However, the tube-shaped protection 10 is not absolutely necessary, at least not for an individual lead. To the extent a cable needs to be built up by two or more leads connected in parallel, of course the string 4 of one of the leads may touch the conductor 7 of the other lead and vice versa, without any major problems arising. In other embodiments, the leads in the cable may be mutually twisted so that the leads rest against each other via the strings thereof. Naturally, such a cable may in turn be enveloped by a shrink tube, which by, for instance, heat treatment, is shrunk on to contact the leads

In a practical production process, a helically cut blank 1 having axially nearby winding turns and an axial length of 1 m, may be threaded onto an end portion of a 15 m long conductor and then be drawn out by the entire length of the conductor in order to, in the extended state, abut against the conductor around the circumference thereof.

FIG. 8 shows an apparatus and a technique by means of which the blank 1 is rotated and axially displaced. The blank 1 may, for instance, be rotated by means of a rotation device 30, which allows the blank to move axially. In doing so, one end of the blank 1 may be received in a throughput channel in a guiding body 32. The throughput channel may be provided with an internal thread 31, which contacts the external surface of the blank, the crests of the thread elastically deforming the surface layer of the outer wall surface of the blank, whereby the blank is given a spiral movement corresponding to the thread 31. On the guiding body 31, a cut blade 33 is shown, which cuts a cut in or through the wall of the tubular blank 1, whereby the strand 4 discussed above is defined. The strand end is connected to the conductor 7, which extends through the blank 1. A pulling string 17 extends through a protective tube (shrink tube 10) and is connected to the conductor and the strand 4 downstream of the body 32. By pulling the pulling string 17, the conductor 7 and the front end of the strand 4 are drawn into the tube 10, the strand spiral being axially extended and coming into abutment around the conductor 7, with spaced-apart winding turns. The tensile force in the pulling cord 17 is adapted so that the strand 4 is not broken, but gets a good abutment around and along the conductor 7. Finally, the rear end of the strand 4 is anchored to the conductor 7. Furthermore, the shrink tube is shrunk onto the conductor 7.

The apparatus shown in FIG. 8 does not necessarily have to have a rotation device 30, since the rotation of the blank 1 may be carried out manually, if desired. Furthermore, the mounting of the protective tube 10 may be carried out in a separate operation after the mounting of the spiral strand 4 on the conductor 7.

1. Method for producing a lead (4, 7), comprising an elongate conductor (7) and a helically shaped string (4) of insulator material coaxially carried by the conductor, which string has axially spaced-apart winding turns, which abut against and along the conductor, characterized in that the string (4) is formed of a tubular blank (1) having a greater inner diameter than the outer diameter of the conductor (7), that the tubular blank (1) is cut along a helically shaped path (2) coaxial with the blank, that the cut blank (1, 2) is threaded coaxially onto the conductor (7) and that the blank is axially extended.

2. Method according to claim 1, characterized in that one end of the blank is clamped to the conductor (7) and that the blank is axially displaced toward the other end of the conductor.

3. Method according to claim 1, characterized in that the blank is cut for the formation of a notch line and that the axial extension of the blank (1) enforces radial breakthrough of the blank along the notch line.

4. Method according to claim 1, characterized in that the blank is cut through the entire tubing wall of the blank.

5. Method according to claim 1, characterized in that the lead is provided with a coaxial tubular protective casing, which is mounted to contact the insulator string abutting against the conductor (7) and bridges over the winding turns thereof at a distance from the surface of the conductor (7).

6. Method according to claim 1, characterized in that the blank, on the inside thereof, has inwardly directed protuberances by which the string rests against the conductor.

7. Method according to claim 6, characterized in that the protuberances are in the form of borders located on the inner surface of the blank, spaced-apart in the circumferential direction, and tapering in the direction radially inward.

8. Lead made by means of the method according to claim 1.
